(19) United States
(12) Patent Application Publication
(10) Pub. No.: US 2025/0315995 A1
(43) Pub. Date: Oct. 9, 2025

(54) WAVEFORM SIGNAL PACKAGING FOR DATA ANALYSIS AND PROCESS CONTROL

(71) Applicant: Applied Materials, Inc., Santa Clara, CA (US)

(72) Inventors: Justin H. WONG, Sunnyvale, CA (US); Devin PON, Santa Clara, CA (US)

(21) Appl. No.: 18/626,965

(22) Filed: Apr. 4, 2024

(51) Int. Cl. G06T 11/20; G06T 11/00

(52) U.S. Cl. CPC G06T 11/206; G06T 11/001

(57) ABSTRACT

A method for process control by waveform signal packaging at a processor device is provided. The processor device may receive time-based waveform data. The time-based waveform data may include waveform data corresponding to one or more waveform signals in a time domain. The processor device may process the time-based waveform data to convert the time-based waveform data into frequency-based waveform data. The frequency-based waveform data may include the waveform data in a frequency domain. The processor device may package the frequency-based waveform data (and/or the time-based waveform data) into one or more spectrogram image files. Each spectrogram image file may include two or more color channels indicating the waveform data. The processor device may display the one or more spectrogram image files.

### BACKGROUND OF THE INVENTION

### Field of the Invention

Embodiments of the present invention generally relate to methods and apparatus for waveform data analysis. More specifically, embodiments of the present invention relate to methods for packaging waveform data into spectrogram image files.

### Background

In electronics, acoustics, and related fields, a waveform of a signal is a graphical representation of the signal in a form of a wave. It can be both sinusoidal as well as square shaped, depending on a type of wave generating input. The waveform depends on properties that define a size and a shape of the wave.

Waveform data may include vibration data, acoustics data, etc. Such waveform data may be time-based or frequency-based waveform data, and may include characteristics that may provide insight into a process or a component (e.g., a mechanical component) generating the waveform data.

In semiconductor systems, a controller (e.g., a semiconductor tool controller) may process the time-based or frequency-based waveform data for the insights into a semiconductor process or a semiconductor system component generating the waveform data. However, operations of the semiconductor tool controller have certain limitations while processing the time-based or frequency-based waveform data. For example, the semiconductor tool controller may only be able to process the waveform data for the insights, which may trend within upper and lower frequency limits but not through unique frequencies that may show up in the waveform data. Accordingly, the semiconductor tool controller may not be able to process all of the time-based or frequency-based waveform data and provide correct insights within a desired time period.

There are also some additional challenges associated with the processing of the waveform data such as the time-based waveform data for data analysis. For example, the time-based waveform data may usually require some form of data processing prior to the data analysis. Such data processing may result in extra cost and processing time.

Additionally, a waveform data rate is proportional to a range of signal frequencies captured. So, any time between data sampling may limit a frequency of the waveform data that can be analyzed. Furthermore, a shorter time between the data sampling may proportionally require more storage space for the waveform data, which may burden a central processing unit (CPU) during fast Fourier transform (FFT)/data analysis of the waveform data. Accordingly, it may not be practical to have multiple streams of the time-based waveform data captured over a long period of time for the data analysis (e.g., as this may require a huge storage space for the waveform data).

Therefore, there is a need for an apparatus and method for analyzing waveform data that solves the problems described above.

### SUMMARY OF THE INVENTION

Embodiments of the invention provide apparatus and methods for waveform data analysis. In one embodiment, an apparatus for waveform signal packaging is provided. The apparatus includes a memory including instructions and one or more processors. The one or more processors, individually or collectively, are configured to execute the instructions and cause the apparatus to: receive time-based waveform data where the time-based waveform data includes waveform data corresponding to one or more waveform signals in a time domain; process the time-based waveform data to convert the time-based waveform data into frequency-based waveform data where the frequency-based waveform data includes the waveform data in a frequency domain; package at least one of the frequency-based waveform data or the time-based waveform data into one or more spectrogram image files where each spectrogram image file includes two or more color channels indicating the waveform data; and at least one of: display or process (e.g., analyze) the one or more spectrogram image files.

In another embodiment, a method of process control by waveform signal packaging at a processor device is provided. The method includes receiving time-based waveform data where the time-based waveform data includes waveform data corresponding to one or more waveform signals in a time domain. The method includes processing the time-based waveform data to convert the time-based waveform data into frequency-based waveform data where the frequency-based waveform data includes the waveform data in a frequency domain. The method includes packaging at least one of the frequency-based waveform data or the time-based waveform data into one or more spectrogram image files where each spectrogram image file includes two or more color channels indicating the waveform data. The method includes at least one of: displaying or processing (e.g., analyzing) the one or more spectrogram image files.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the present invention are attained and can be understood in detail, a more particular description of the invention, briefly summarized above, may be had by reference to the embodiments thereof which are illustrated in the appended drawings.

FIG. 1 is a partial sectional view of one embodiment of a polishing station which may be used to practice embodiments of the invention.

FIG. 2 is a schematic plan view of the polishing station of FIG. 1, according to one or more embodiments.

FIGS. 3A and 3B depict a process for waveform data packaging and analysis, according to one or more embodiments.

FIG. 4 depicts an example accelerometer data spectrogram, according to one or more embodiments.

FIG. 5 depicts an example acoustic data spectrogram, according to one or more embodiments.

FIG. 6 depicts an example vibration data spectrogram, according to one or more embodiments.

FIG. 7 depicts a method for waveform data packaging and analysis, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein relate to apparatus and methods to capture and analyze a large volume of waveform data (e.g., accelerometer waveform data, audio waveform data) collected during the performance of one or more activities, such as semiconductor processing activates. In some embodiments, the apparatus and methods include transforming large volumes of waveform data into fast Fourier transform (FFT) spectrogram image files, which may have a low data storage footprint. The FFT spectrogram image files are lossless image files, which may allow for multiple channels or streams (e.g., four channels) of the waveform data to be embedded into one spectrogram image file. Accordingly, the apparatus and methods described herein may facilitate the multiple channels or streams of the waveform data to be stored and analyzed with minimal data storage requirements and lower central processing unit (CPU) processing burden (e.g., as the multiple channels or streams of the waveform data can be embedded into a single spectrogram image file having one or more color channels).

### Example Chemical Mechanical Polishing (CMP) System

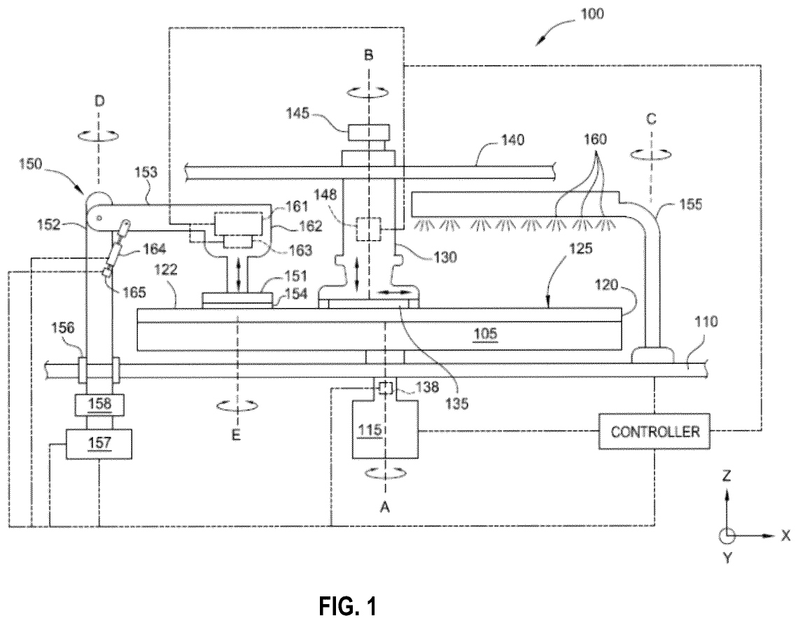

FIG. 1 is a partial sectional view of one embodiment of a polishing station 100 that is configured to perform a polishing process, such as a chemical mechanical polishing (CMP) process, grinding process, or an electrochemical mechanical polishing (ECMP) process. The polishing station 100 may be a stand-alone unit or part of a larger processing system. Examples of a larger processing system that may be adapted to utilize the polishing station 100 include REFLEXION®, REFLEXION® LK, REFLEXION® LK ECMP™ REFLEXION GT™, and MIRRA MESA® polishing systems available from Applied Materials, Inc., located in Santa Clara, California, among other polishing systems.

The polishing station 100 includes a platen 105 rotatably supported on a base 110. The platen 105 is operably coupled to an actuator or drive motor 115 adapted to rotate the platen 105 about a rotational axis A. In one embodiment, the polishing material 122 of the polishing pad 120 is a commercially available pad material, such as polymer based pad materials typically utilized in CMP processes. The polymer material may be a polyurethane, a polycarbonate, fluoropolymers, polytetrafluoroethylene (PTFE), polyphenylene sulfide (PPS), or combinations thereof. The polishing material 122 may further comprise open or closed cell foamed polymers, elastomers, felt, impregnated felt, plastics, and like materials compatible with the processing chemistries. In another embodiment, the polishing material 122 is a felt material impregnated with a porous coating. In other embodiments, the polishing material 122 includes a material that is at least partially conductive. The polishing pad 120 is considered a consumable and may be releasably coupled to the platen 105 to facilitate replacement of the polishing pad 120.

The platen 105 is utilized to rotate the polishing pad 120 during processing such that the polishing pad 120 planarizes or polishes the surface of a substrate 135 when the substrate is in contact with the polishing material 122. In some embodiments, a first measurement device 138, such as a platen rotational sensor may be utilized to obtain a metric indicative of the force required to rotate the platen 105 and polishing pad 120. The first measurement device 138 may be a torque or other rotational force sensor coupled to the drive motor 115, or to an output shaft of the drive motor 115. In some embodiments, the first measurement device 138 may include an accelerometer, a temperature sensor, an acoustic sensor, a friction sensor, and a pressure sensor, or other useful sensor or data collection device.

A carrier head 130 is disposed above a polishing surface 125 of the polishing pad 120. The carrier head 130 retains the substrate 135 and controllably urges the substrate 135 towards the polishing surface 125 (along the Z axis) of the polishing pad 120 during processing. In one embodiment, the carrier head 130 includes one or more pressurizable bladders (not shown) that are adapted to apply a pressure or force to one or more zones of the backside of the substrate 135 to urge the substrate 135 toward the polishing surface 125. The carrier head 130 is mounted to a support member 140 that supports the carrier head 130 and facilitates movement of the carrier head 130 relative to the polishing pad 120. The support member 140 may be coupled to the base 110 or mounted on the polishing station 100 in a manner that suspends the carrier head 130 above the polishing pad 120. In one embodiment, the support member 140 is a circular track that is mounted on or adjacent the polishing station 100 above the polishing pad 120.

The carrier head 130 is coupled to a drive system 145 that provides at least rotational movement of the carrier head 130 about a rotational axis B. The drive system 145 may additionally be configured to move the carrier head 130 along the support member 140 laterally (X and/or Y axes) relative to the polishing pad 120. In one embodiment, the drive system 145 moves the carrier head 130 vertically (Z axis) relative to the polishing pad 120 in addition to lateral movement. For example, the drive system 145 may be utilized to move the substrate 135 towards the polishing pad 120 in addition to providing rotational and/or lateral movement of the substrate 135 relative to the polishing pad 120. The lateral movement of the carrier head 130 may be a linear or an arcing or sweeping motion. A second measurement device 148 may be coupled to the carrier head 130. In some embodiments, the second measurement device 148 may be a rotational sensor for the carrier head 130 that is utilized to obtain a metric of force required to rotate the substrate 135 against the polishing pad 120. The second measurement device 148 may be a torque or other rotational force sensor coupled to the drive system 145, or an output shaft of the drive system 145. In some embodiments, the second measurement device 148 may include an accelerometer, a temperature sensor, an acoustic sensor, a friction sensor, and a pressure sensor, or other useful sensor or data collection device.

A conditioner device 150 and a fluid applicator 155 are shown positioned over the polishing surface 125 of the polishing pad 120. The fluid applicator 155 includes one or more nozzles 160 adapted to deliver polishing fluids to a portion of the polishing pad 120. The fluid applicator 155 is rotatably coupled to the base 110. In some aspects, the fluid applicator 155 may not be rotatably coupled to the base 110. In one embodiment, the fluid applicator 155 is adapted to rotate about a rotational axis C and provides a polishing fluid that is directed toward the polishing surface 125. The polishing fluid may be a chemical solution, water, a polishing compound, a cleaning solution, or a combination thereof.

The conditioner device 150 generally includes a conditioner head 151, a rotatable shaft 152, and an arm 153 configured to extend from the rotatable shaft 152 above the polishing pad 120 and support the conditioner head 151. The conditioner head 151 retains a conditioner disk 154 which is selectively placed in contact with the polishing surface 125 of the polishing pad 120 to condition the polishing surface 125. The conditioner disk 154 is considered a consumable and is releasably coupled to the conditioner head 151 to facilitate replacement of the conditioner disk 154.

The rotatable shaft 152 is disposed through the base 110 of the polishing station 100. The rotatable shaft 152 may rotate about a rotational axis D relative to the base 110. The rotation of the rotatable shaft 152 may be facilitated by bearings 156 between the base 110 and the rotatable shaft 152 such that the arm 153 rotates the conditioner head 151 relative to the base 110 and the polishing pad 120. In one embodiment, an actuator or motor 157 is coupled to the rotatable shaft 152 to rotate the rotatable shaft 152 and urge the arm 153 and the conditioner head 151 in a sweeping motion across the polishing surface 125 of the polishing pad 120.

The conditioner device 150 further includes a third measurement device 158 utilized to monitor the rotation of the rotatable shaft 152. In one embodiment, the third measurement device 158 is a rotational sensor utilized in conjunction with the rotatable shaft 152 and/or the arm 153 that is adapted to detect rotational force or torque required to move the conditioner disk 154 in the sweeping motion across the polishing surface 125 of the polishing pad 120. In some example embodiments, the third measurement device 158 may be a torque or other rotational force sensor coupled to the motor 157 or an output shaft of the motor 157. In other embodiments, the third measurement device 158 may be an electrical current sensor or pressure sensor coupled to the motor 157. An electrical current sensor may detect changes in the electrical current drawn by the motor 157 as the frictional forces between the conditioner disk 154 and the polishing surface 125 of the polishing pad 120 change. A pressure sensor may interface with the motor 157 to detect changes in the pressure utilized to actuate the motor 157 as the frictional forces between the conditioner disk 154 and the polishing surface 125 of the polishing pad 120 change. In still other embodiments, the third measurement device 158 may be any other sensor suitable for providing a metric indicative of the force required to move the conditioner disk 154 across the polishing surface 125 of the polishing pad 120.

The conditioner head 151 rotates the conditioner disk 154 about the rotational axis E disposed orthogonally through the conditioner disk 154. An actuator or motor 161 is utilized to rotate the conditioner disk 154 relative to the arm 153 and/or the polishing surface 125 of the polishing pad 120. In one embodiment, the motor 161 is disposed in a housing 162 at a distal end of the arm 153. The conditioner disk 154 is fabricated from a material suitable for conditioning the material of the polishing pad 120. The conditioner disk 154 may be a brush having bristles made of a polymer material or include an abrasive surface comprising abrasive particles. In one embodiment, the conditioner disk 154 comprises a surface containing abrasive particles, such as diamonds or other relatively hard particles adhered to a base substrate.

The conditioner device 150 further includes a fourth measurement device 163 to sense rotational force or torque required to rotate the conditioner disk 154 about the rotational axis E when the conditioner disk 154 is in contact with the polishing pad 120. In one embodiment, the fourth measurement device 163 may be a torque sensor to sense torque experienced by the conditioner head 151. In one aspect, the fourth measurement device 163 is disposed within the housing 162. In one embodiment, the fourth measurement device 163 may be an electrical current sensor coupled to the motor 161 or an output shaft coupled between the motor 161 and the conditioner disk 154. An electrical current sensor may detect changes in the current drawn by the motor 161 as the frictional forces between the conditioner disk 154 and the polishing surface 125 of the polishing pad 120 change. In another embodiment, the fourth measurement device 163 may be a torque sensor, deflection sensor or strain gauge, positioned in the drive train between the motors and the conditioner head to measure forces on the drive train caused by friction between the conditioner disk 154 and the polishing surface 125 of the polishing pad 120.

The conditioning device 150 also includes a down-force actuator 164 which is utilized to urge the conditioner disk 154 against the polishing surface 125 of the polishing pad 120. The down-force actuator 164 is configured to selectively control the force applied by the conditioner disk 154 against the polishing surface 125 of the polishing pad 120. In one embodiment, the down-force actuator 164 may be disposed between the arm 153 and the shaft 152, or other suitable location. In other embodiments (not shown), arm 153 is statically coupled to the rotatable shaft 152 and the down-force actuator 164 is disposed between a distal end of the arm 153 and the conditioner head 151 to control the force applied by the conditioner disk 154 against the polishing surface 125 of the polishing pad 120.

A fifth measurement device 165 is coupled to the down-force actuator 164 and may be utilized to detect a metric indicative of the down-force of the conditioner disk 154 against the polishing surface 125 of the polishing pad 120. In one embodiment, the fifth measurement device 165 is a down-force sensor that may be positioned with or coupled to the down-force actuator 164 in an in-line orientation, or other suitable location that is utilized to detect stress or strain of the down-force actuator 164 relative to the rotatable shaft 152, or other mounting location.

Each of the drive system 145, the down-force actuator 164, the motors 115, 157 and 161, as well as the measurement devices 138, 148, 158, 163 and 165 are coupled to one or more controllers. In some cases, the motors 115, 157 and 161 may be controlled by a tool controller, and a different controller may be used to collect data from one or more sensors. In some cases, the one or more controllers may relay data between each other. In general, the controller is used to control one or more components and processes performed in the polishing station 100. In one embodiment, the controller uses sensory data to control the rate of material removed from the substrate 135 during processing. The controller transmits control signals to the drive system 145, the down-force actuator 164, and the motors 115, 157 and 161, and receives signals corresponding to one or more measured process characteristics, such as temperatures, accelerations, or forces detected by the measurement devices 138, 148, 158, 163 and 165. The controller is generally designed to facilitate the control and automation of the polishing station 100 and typically includes a central processing unit (CPU), memory, and support circuits (or I/O). The CPU may be one of any form of computer processors that are used in industrial settings for controlling various system functions, substrate movement, polishing processes, process timing and support hardware (e.g., sensors, robots, motors, timing devices, etc.), and monitor the processes (e.g., chemical concentrations, processing variables, process time, I/O signals, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program, or computer instructions, readable by the controller determines which tasks are performable on a substrate. Preferably, the program is software readable by the controller that includes code to perform tasks relating to monitoring, execution and control of the movement, support, and/or positioning of a substrate in the polishing station 100. In one embodiment, the controller is used to control robotic devices to control the strategic movement, scheduling and running of the polishing station 100 to make the processes repeatable, resolve queue time issues and prevent over or under processing of the substrates.

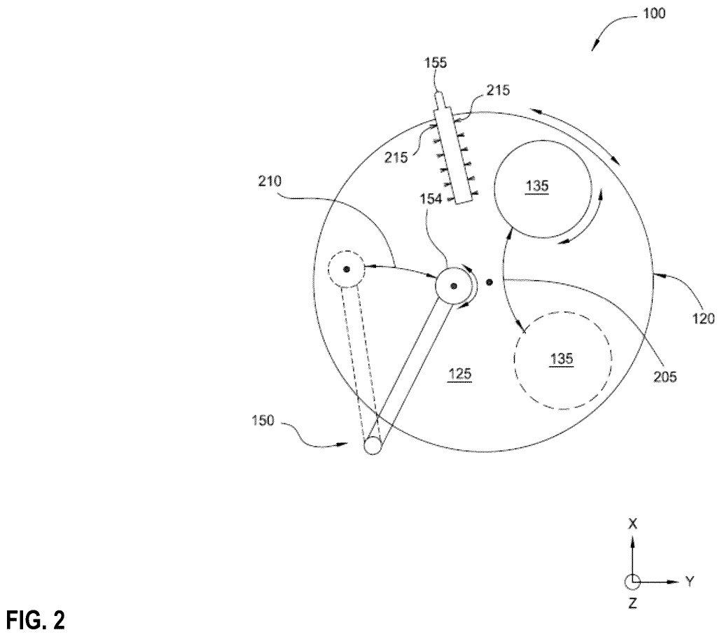

FIG. 2 is a schematic plan view of the polishing station 100 of FIG. 1. The carrier head 130 (FIG. 1) is not shown in order to an embodiment of a polishing sweep pattern 205 of the substrate 135 on the polishing pad 120 as the substrate 135 is retained in the carrier head 130. The carrier head moves the substrate 135 linearly or in an arc across the polishing surface 125 while rotating the substrate 135 relative to the rotating polishing pad 120 to effect removal of material from the substrate 135. The conditioning device 150 having a conditioner disk 154 is also shown to illustrate one embodiment of a conditioning sweep pattern 210 on the polishing pad 120. The conditioner disk 154 is swept across the polishing surface 125 to condition and/or refresh the polishing surface 125 to facilitate an enhanced removal rate of material from the substrate 135.

In operation, as illustrated in FIG. 2, a polishing fluid 215 is delivered to the polishing surface 125 of the polishing pad 120 by the polishing fluid applicator 155. In one embodiment, the platen 105 is rotated at a rotational velocity of about 85 revolutions per minute (RPM) to about 100 RPM, such as about 93 RPM. The carrier head 130 (not shown) urges the substrate 135 against the polishing surface 125 of the polishing pad 120. In one embodiment, the carrier head 130 is rotated relative to the platen 105 at a rotational velocity of about 80 RPM to about 95 RPM, such as about 87 RPM. One or more pressurizable bladders within the carrier head 130 may apply a pressure to the backside of the substrate 135 to urge the substrate 135 toward the polishing pad 120. In one embodiment, the average pressure is about 3.5 pounds per square inch (psi) to about 5.5 psi, such as about 4.5 psi. Contact with the polishing surface 125 of the rotating polishing pad 120 in the presence of the polishing fluid 215 removes excess metallic, dielectric and/or barrier materials from the substrate and planarizes the surface of the substrate 135 that is in contact with the polishing pad 120.

Before, during and/or after performing a polishing process on the substrate 135, the polishing pad 120 is conditioned to regenerate asperities, remove polishing by-products and pad debris, and refresh the polishing surface 125. During conditioning, the conditioner head 151 urges against the conditioner disk 154 against the polishing pad 120 with a pre-defined down-force. The conditioner disk 154 rotates relative to the polishing surface 125 of the polishing pad 120 while sweeping back and forth across the polishing pad 120 in the conditioning sweep pattern 210.

### Example Waveform Data Packaging

Embodiments described herein relate to a low data footprint method to store waveform data, which may be packaged as fast Fourier transform (FFT) spectrogram image files. The packaging of the waveform data as the FFT spectrogram image files may enable large-scale FFT data collection for analysis and improved historical data retrieval.

In certain aspects, using lossless image file types, such as a portable network graphic (PNG), multiple waveform data channels or streams (e.g., up to four waveform data streams) may be encoded into each spectrogram image file. A lossless compression may be a class of data compression that allows original data to be perfectly reconstructed from compressed data with no loss of information.

The use of the spectrogram image file for presenting a large volume of the waveform data may facilitate long term trending waveform data to be harnessed and processed for detection of anomalies (e.g., based on comparisons of different spectrogram image files and/or using artificial intelligence (AI) trained image/object detection algorithms).

For example, during a chemical mechanical polishing (CMP) polishing process, multiple cycles of the polishing process may be performed. A data logger device may monitor and collect waveform data (e.g., vibration data) corresponding to at least one component of a polishing station during each cycle/run of the polishing process. The collected waveform data for each cycle may be packaged as different spectrogram image files. By comparing the different spectrogram image files, similarity or differences in forces, vibrations or other dynamic motions of the component of the polishing station during each cycle may be determined, a source for a likely failure of the component of the polishing station may be detected, and/or a need for a change of some component (e.g., a polishing pad) may be determined based on a current vibration behavior.

Particular aspects of subject matter described in this disclosure can be implemented to realize one or more of following potential advantages. In some examples, the described embodiments may provide a reduced or low data storage footprint of the waveform data (e.g., 80× reduction in data storage). For example, a large volume of the waveform data (e.g., multiple hours of waveform data) can be packaged in a spectrogram image file having a size of only a few kilo bytes.

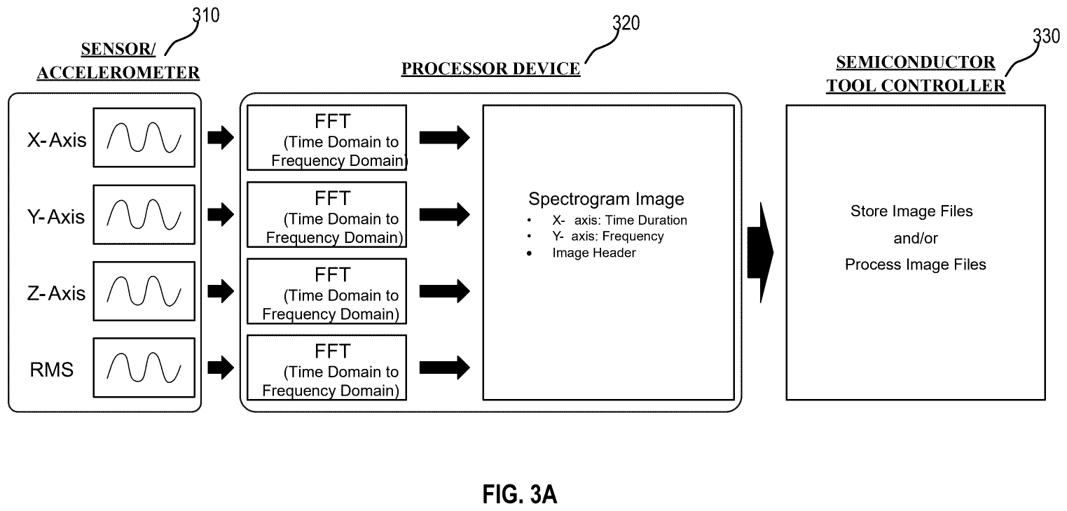

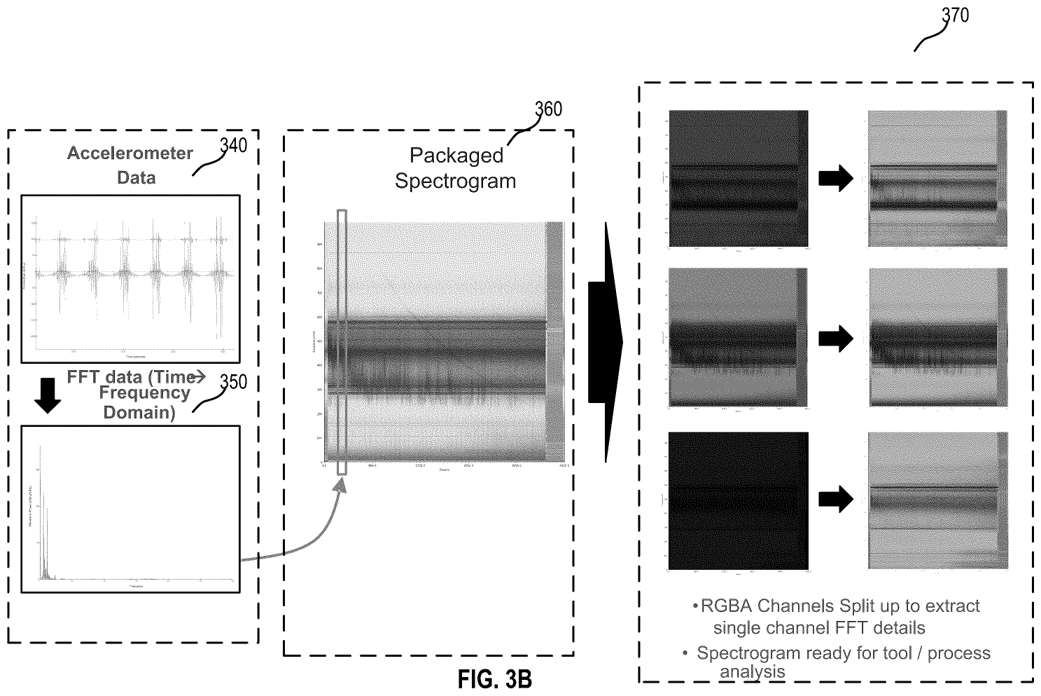

Techniques proposed herein for packaging the waveform data into the spectrogram image files may be understood with reference to FIGS. 3A-7.

FIGS. 3A and 3B depict a process for waveform data packaging and analysis (e.g., which may be utilized or implemented with the polishing station 100 of FIGS. 1 and 2). The process described herein may enable one or more waveform data signals/channels/streams to be packaged into a single spectrogram image file (e.g., which can include up to four waveform data signals/channels/streams) for data analysis, data heuristics, and/or data metrology.

At 310, a device (e.g., a sensing device) may monitor and collect waveform data (e.g., time-based waveform data, which may be accelerometer data 340 shown in FIG. 3B) at a certain sampling rate (e.g., which may be a high sampling rate such as two kilohertz (KHz)) or a certain sampling frequency.

The waveform data may be derived from the monitoring of seismic and acoustic waves of one or more components (e.g., of the polishing station 100 of FIGS. 1 and 2). The sampling rate may indicate an average number of samples obtained in one second (e.g., samples per second). The time-based waveform data may include the waveform data corresponding to one or more waveform signals in a time domain.

The sensing device may be an accelerometer such as 3-axis accelerometer. The 3-axis accelerometer may be a type of accelerometer that can measure acceleration in three orthogonal directions (or three perpendicular planes such as X, Y, and Z planes). Accordingly, the 3-axis accelerometer may measure the time-based waveform data in X plane, the time-based waveform data in Y plane, and the time-based waveform data in Z plane. In some cases, the 3-axis accelerometer may also measure root mean square (RMS) data. In another example, the device may be a sensor. In yet another example, the device may be a microphone. In yet another example, the device may be a strain gauge.

The sensing device may send the time-based waveform data to a processor device. In one example, the processor device may be an external computer, which may be associated with the sensing device. In another example, the processor device may be a localized central processing unit (CPU) coupled to or in communication with the sensing device.

At 320, the processor device may receive the time-based waveform data (e.g., in all planes and/or the RMS data). The processor device may process the time-based waveform data. For example, the processor device may process the time-based waveform data to convert the time-based waveform data into frequency-based waveform data. The frequency-based waveform data may include the waveform data (e.g., in all planes and/or the RMS data) in a frequency domain.

The processor device may use a fast Fourier transform (FFT) to convert the time-based waveform data (e.g., in all planes and/or the RMS data) into frequency-based waveform data (e.g., such as FFT data 350 shown in FIG. 3B). The FFT may be an algorithm that computes discrete Fourier transform (DFT) of a sequence, or its inverse (IDFT). The Fourier analysis converts a waveform signal from its original domain (e.g., time domain) to a representation in a frequency domain and vice versa. The DFT is obtained by decomposing a sequence of values into components of different frequencies.

The processor device may package (or convert) the frequency-based waveform data into one or more spectrogram image files (e.g., such as a packaged spectrogram 360 including multiple color channels shown in FIG. 3B). For example, a spectrogram image file may be a visual representation of a spectrum of frequencies of the one or more waveform signals as it varies with time.

In certain aspects, Y-axis of the spectrogram image file may represent a magnitude of frequencies of the waveform data and X-axis of the spectrogram image file may represent a time when corresponding frequencies of the waveform data were captured.

In certain aspects, as shown in FIG. 3B, each spectrogram image file may include two or more color channels indicating the multiple channels or streams of the waveform data. For example, multiple FFT data streams may be packaged (e.g., up to four waveform data streams) into the spectrogram image files (e.g., such as lossless image files) using different color channels such as a red color channel (e.g., shown in the left hand box of the top row in the data extraction step 370), a green color channel (e.g., shown in left hand box of the middle row in the data extraction step 370), a blue color channel (e.g., shown in left hand box of the lower row in the data extraction step 370), and/or an alpha channel (e.g., not shown in the data extraction step 370).

In certain aspects, spectrogram image data (e.g., 8 bit, 10 bit, or 12 bit data) may encode red color, green color, blue color, and alpha data, which may allow multiple (e.g., ≥4×) FFT data streams/spectrograms to be embedded together. For example, data measured by the accelerometer such as the time-based waveform data in X plane, the time-based waveform data in Y plane, the time-based waveform data in Z plane, and the RMS data may be packaged into a single spectrogram image file. Per image data structure of the spectrogram image file, a red color channel of the spectrogram image file may represent the accelerometer X plane FFT data, a green color channel of the spectrogram image file may represent the accelerometer Y plane FFT data, a blue color channel of the spectrogram image file may represent the accelerometer Z plane FFT data, and an alpha channel of the spectrogram image file may represent the accelerometer RMS FFT data.

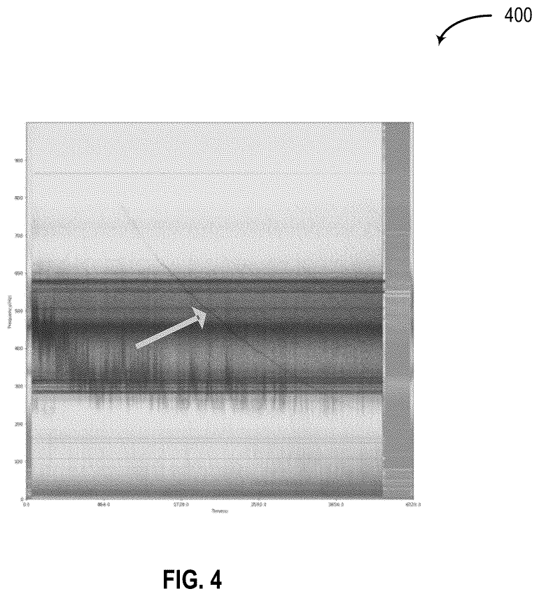

In certain aspects, the spectrogram image file may be depicted as a heat map, i.e., as an image with intensity shown by varying colors or brightness, as schematically illustrated on the right side of the packaged spectrogram 360 of FIG. 3B or 4. For example, a magnitude of intensity (or an image bitrate) of the spectrogram image file may be set as an absolute or a relative scale, and represented by color intensity of an image pixel (e.g., either a single color channel or combined).

In certain aspects, each spectrogram image file may include a header. The header may include information such as a timestamp, various processing tool metadata, and other details.

The processor device may transmit the one or more spectrogram image files to a semiconductor tool controller (e.g., which may be part of or associated with the polishing station 100 of FIGS. 1 and 2).

At 330, the semiconductor tool controller may receive the one or more spectrogram image files. Each spectrogram image file may represent a certain timescale (e.g., one minute spectrogram image file may be equal to 60 pixels in image width) and/or spectrogram data magnitude (e.g., waveform data magnitude (Y-axis)).

The semiconductor tool controller may store the one or more spectrogram image files. For example, the semiconductor tool controller may store the one or more spectrogram image files in a database (e.g., which may be part of or associated with the polishing station 100 of FIGS. 1 and 2) as historical telemetry data.

The semiconductor tool controller may process and analyze the one or more spectrogram image files. For example, the semiconductor tool controller may perform image analysis on the one or more spectrogram image files (i.e., packaged FFT images) to monitor for trends and tracking of objects within the one or more spectrogram image files.

In another example, the semiconductor tool controller may process the one or more spectrogram image files to extract different color channels (e.g., the red color channel, the green color channel, the blue color channel, and/or the alpha channel as shown at data extraction step 370 in FIG. 3B) to identify different waveform streams with frequency anomalies and/or excursions.

In yet another example, the semiconductor tool controller may process the one or more spectrogram image files to perform tracking of FFT changes for a wafer process control and/or process consumable behavioral changes.

FIG. 4 depicts a diagram 400 showing an accelerometer data spectrogram, which may represent accelerometer data using different color channels. A semiconductor tool controller may process the accelerometer data spectrogram to track frequency and/or vibrational changes over consumable lifetime. In some cases, the semiconductor tool controller may process the accelerometer data spectrogram to monitor an accelerometer device health through determining abrupt and/or gradual changes to spectrogram output of the accelerometer device. In one example, as illustrated and highlighted by the arrow in FIG. 4, a trend in one or more of the sensed data includes a gradual decrease in the magnitude of the plotted spectrogram data which illustrates a drift in a measure property within the processing chamber (e.g., polishing station) over a period of time.

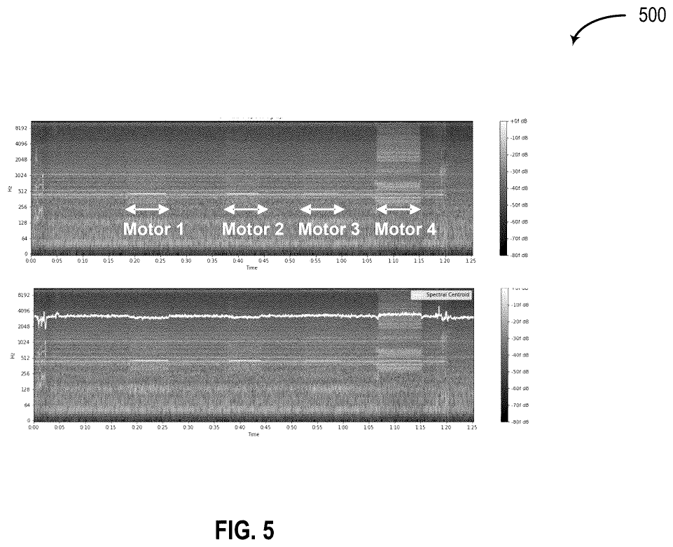

FIG. 5 depicts a diagram 500 showing an example of an acoustic data spectrogram, which may represent acoustic data associated with a motor noise and other environmental acoustics using different color channels. A semiconductor tool controller may process the acoustic data spectrogram to detect different hardware excursions that may be detected but are not immediately evident when directly measuring motor torque or other telemetry feedback. The ability to compare multiple sensor data over time will allow a rapid and easy comparison that can detect anomalies in the functioning of similar devices. As illustrated in FIG. 5, the signals detected for motors 1-4, and processed by the techniques provided herein to form the spectrogram, illustrate the difference in the performance of motor 4 versus the other motors 1-3. The data presented in the spectrogram will allow a user to quickly inspect the spectrogram if it is being displayed or be notified by the controller that there may be a problem with motor 4 so that it can be inspected and/or replaced.

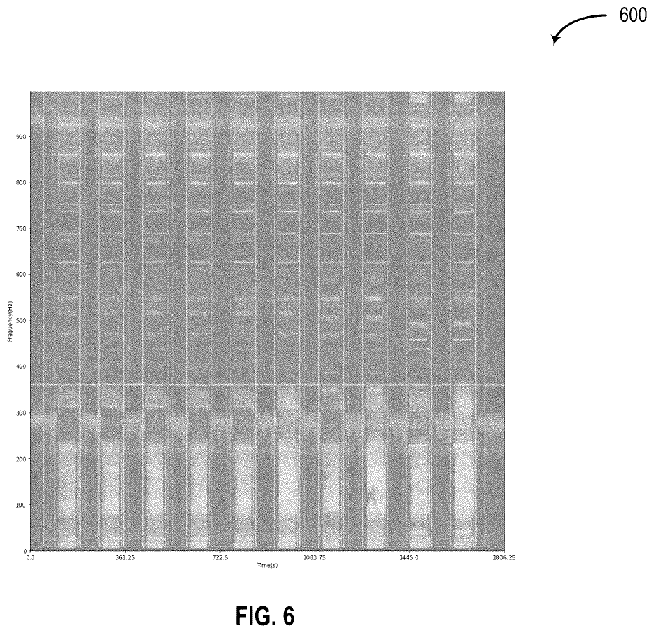

FIG. 6 depicts a diagram 600 showing a vibration data spectrogram, which may represent vibration data (i.e., frequency vs. time) associated with one or more components (e.g., which may be part of or associated with the polishing station 100 of FIGS. 1 and 2) using different color channels. A semiconductor tool controller may process the vibration data spectrogram to observe different vibration modes associated with different components at different times. As illustrated in FIG. 6, the signals detected over time include the increasing presence or intensity of the signals collected at various frequencies, such as frequencies surrounding 300 hertz (Hz). The data presented in the vibrational data spectrogram will allow a user to quickly understand that a problem with one or more devices within the system may need to be inspected and/or replaced.

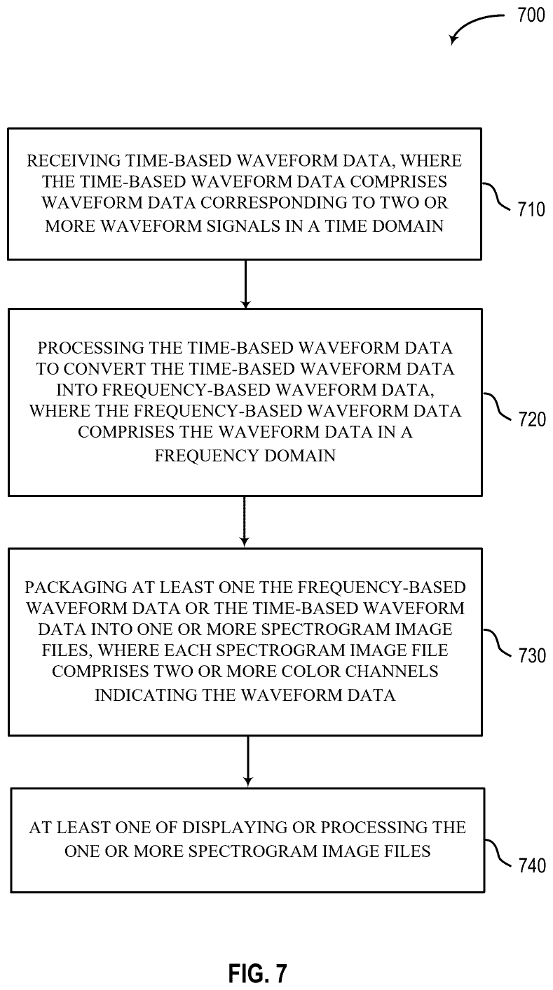

FIG. 7 is a flowchart depicting one embodiment of a method 700 of process control by waveform signal packaging at a processor device (e.g., which may be utilized or implemented with the polishing station 100 of FIGS. 1 and 2).

Method 700 begins at step 710 with receiving time-based waveform data. The time-based waveform data may include waveform data corresponding to one or more waveform signals in a time domain. In some embodiments, the time based data will include a variation in a measured property as a function of time.

In one example, the time-based waveform data may include the waveform data corresponding to two waveform signals in the time domain. In another example, the time-based waveform data may include the waveform data corresponding to four waveform signals in the time domain.

In certain aspects, the time-based waveform data may be received from one or more accelerometer devices. In such cases, the time-based waveform data may be associated with a sampling rate of the one or more accelerometer devices.

In certain aspects, the time-based waveform data may be received from one or more microphone devices. In such cases, the time-based waveform data may be associated with a sampling rate of the one or more microphone devices.

In certain aspects, the time-based waveform data may be received from one or more sensor devices. In such cases, the time-based waveform data may be associated with a sampling rate of the one or more sensor devices.

In one example, the time-based waveform data includes a measurement of a varying magnitude of an acceleration, vibration, temperature, force or other desirable detected parameter over time.

Method 700 then proceeds to step 720 with processing the time-based waveform data to convert the time-based waveform data into frequency-based waveform data. The frequency-based waveform data includes the waveform data in a frequency domain.

In certain aspects, the time-based waveform data may be converted into the frequency-based waveform data using a fast Fourier transform (FFT) algorithm.

Method 700 then proceeds to step 730 with packaging at least one of the frequency-based waveform data or the time-based waveform data into one or more spectrogram image files.

In certain aspects, each spectrogram image file may include two or more color channels indicating the waveform data.

In certain aspects, each spectrogram image file may be a lossless compressed image file. A first axis of the lossless compressed image file may represent a magnitude of frequencies associated with the waveform data and a second axis of the lossless compressed image file may represent a time at which the corresponding frequencies are captured.

In certain aspects, the two or more color channels may include a first color (e.g., red color) channel, a second color (e.g., green color) channel, a third color (e.g., blue color) channel, and/or an alpha channel. In some aspects, the two or more color channels may include a cyan color channel, a magenta color channel, a yellow color channel, and/or a black color channel. In some aspects, the two or more color channels may include any other color channels.

In certain aspects, one or more color channels in the each spectrogram image file may indicate the waveform data associated with a same or a different axis of an accelerometer device, a microphone device, a strain gauge device, and/or a sensor device.

In certain aspects, the packaging of at least one the frequency-based waveform data or the time-based waveform data into the one or more spectrogram image files may include encoding one or more FFT streams corresponding to the waveform data into the two or more color channels of the one or more spectrogram image files.

In certain aspects, each of the one or more spectrogram image files may include a header indicating a spectrogram timestamp, a wafer identification (ID), telemetric data or other relevant metadata.

Method 700 then proceeds to step 740 with at least one of displaying or processing (e.g., analyzing) the one or more spectrogram image files on a display device.

In certain aspects, the processor device may transmit the one or more spectrogram image files to a controller (e.g., a semiconductor tool controller) for image processing/analysis (e.g., for anomaly detection, signal processing etc.).

In certain aspects, the processor device may set a magnitude of color intensity of the one or more spectrogram image files in an absolute scale.

In certain aspects, the processor device may set a magnitude of color intensity of the one or more spectrogram image files in a relative scale.

In some embodiments, after performing the image analysis the controller is configured to cause notification data to be sent to a display device (e.g., banner on a display screen) or to the user (e.g., text message, warning light, etc.) based on an attribute detected in the spectrogram image file(s).

While the foregoing is directed to embodiments of the present invention, other and further embodiments of the invention may be devised without departing from the basic scope thereof, and the scope thereof is determined by the claims that follow.

The patent or application file contains at least one drawing executed in color. Copies of this patent or patent application publication with color drawing(s) will be provided by the Office upon request and payment of the necessary fee.

What is claimed is:

1. A method of process control by waveform signal packaging at a processor device, comprising:
receiving time-based waveform data, wherein the time-based waveform data comprises waveform data corresponding to one or more waveform signals in a time domain;
processing the time-based waveform data to convert the time-based waveform data into frequency-based waveform data, wherein the frequency-based waveform data comprises the waveform data in a frequency domain;
packaging at least one of the frequency-based waveform data or the time-based waveform data into one or more spectrogram image files, wherein each spectrogram image file comprises two or more color channels indicating the waveform data; and
displaying the one or more spectrogram image files.

2. The method of claim 1, wherein:
each spectrogram image file is a lossless compressed image file; and
a first axis of the lossless compressed image file represents a magnitude of frequencies associated with the waveform data and a second axis of the lossless compressed image file represents a time at which the corresponding frequencies are captured.

3. The method of claim 1, wherein the two or more color channels comprise at least a first color channel, a second color channel, a third color channel, and an alpha channel.

4. The method of claim 1, wherein the receiving the time-based waveform data comprises receiving the time-based waveform data from at least one of: one or more accelerometer devices, one or more microphone devices, one or more strain gauge devices, or one or more sensor devices.

5. The method of claim 4, wherein the time-based waveform data is associated with a sampling rate of the at least one of: the one or more accelerometer devices, the one or more microphone devices, or the one or more sensor devices.

6. The method of claim 4, wherein one or more color channels in the each spectrogram image file indicates the waveform data associated with a same or a different axis of an accelerometer device, a microphone device, or a sensor device.

7. The method of claim 1, wherein the processing comprises converting the time-based waveform data into the frequency-based waveform data using a fast Fourier transform (FFT) algorithm.

8. The method of claim 7, wherein the packaging further comprises encoding two or more FFT streams corresponding to the waveform data into the two or more color channels of the one or more spectrogram image files.

9. The method of claim 1, further comprising transmitting the one or more spectrogram image files to a semiconductor controller for image analysis.

10. The method of claim 1, further comprising setting a magnitude of color intensity of the one or more spectrogram image files in an absolute scale or a relative scale.

11. The method of claim 1, wherein each of the one or more spectrogram image files comprises a header indicating at least one of: a spectrogram timestamp, a wafer identification (ID), or telemetric data.

12. An apparatus for waveform signal packaging, comprising:
a memory comprising instructions; and
one or more processors, individually or collectively, configured to execute the instructions and cause the apparatus to:
receive time-based waveform data, wherein the time-based waveform data comprises waveform data corresponding to one or more waveform signals in a time domain;
process the time-based waveform data to convert the time-based waveform data into frequency-based waveform data, wherein the frequency-based waveform data comprises the waveform data in a frequency domain;
package at least one of the frequency-based waveform data or the time-based waveform data into one or more spectrogram image files, wherein each spectrogram image file comprises two or more color channels indicating the waveform data; and
display the one or more spectrogram image files.

13. The apparatus of claim 12, wherein:
each spectrogram image file is a lossless compressed image file; and
a first axis of the lossless compressed image file represents a magnitude of frequencies associated with the waveform data and a second axis of the lossless compressed image file represents a time at which the corresponding frequencies are captured.

14. The apparatus of claim 12, wherein the two or more color channels comprise at least a first color channel, a second color channel, a third color channel, and an alpha channel.

15. The apparatus of claim 12, wherein receiving the time-based waveform data comprises receive the time-based waveform data from at least one of: one or more accelerometer devices, one or more microphone devices, one or more strain gauge devices, or one or more sensor devices.

16. The apparatus of claim 15, wherein the time-based waveform data is associated with a sampling rate of the at least one of: the one or more accelerometer devices, the one or more microphone devices, or the one or more sensor devices.

17. The apparatus of claim 16, wherein one or more color channels in the each spectrogram image file indicates the waveform data associated with a same or a different axis of an accelerometer device, a microphone device, or a sensor device.

18. The apparatus of claim 12, wherein the process comprises converting the time-based waveform data into the frequency-based waveform data using a fast Fourier transform (FFT) algorithm.

19. The apparatus of claim 18, wherein the package further comprises encode one or more FFT streams corresponding to the waveform data into the two or more color channels of the one or more spectrogram image files.

20. The apparatus of claim 12, wherein the one or more processors, individually or collectively, are configured to execute the instructions and cause the apparatus to transmit the one or more spectrogram image files to a semiconductor controller for image analysis.
